(19) United States
(12) Patent Application Publication
(10) Pub. No.: US 2011/0191562 A1
(43) Pub. Date: Aug. 4, 2011

(54) Apparatus and method for partitioning, sandboxing and protecting external memories

(75) Inventors: Paul Chou, Santa Clara, CA (US); Love Kothari, Sunnyvale, CA (US); Lawrence J. Madar, III, San Francisco, CA (US); Ravi Sreenivasa Setty, Santa Clara, CA (US); Dharmvir Singh, Bangalore (IN)

(73) Assignee: BROADCOM CORPORATION, Irvine, CA (US)

(21) Appl. No.: 12/714,367

(22) Filed: Feb. 26, 2010

Related U.S. Application Data
(60) Provisional application No. 61/300,798, filed on Feb. 2, 2010.

(51) Int. Cl. G06F 12/14; G06F 12/06

(52) U.S. Cl. 711/163; 711/173; 711/E12.084; 711/E12.091

(57) ABSTRACT

A technique to provide an integrated circuit that performs memory partitioning to partition a memory into a plurality of regions, in which the memory is accessed by a plurality of heterogeneous processing devices that operate to access the memory. The integrated circuit also assigns a security level for each region of the memory and permits a memory access by a transaction to a particular region of the memory, only when a level of security assigned to the transaction meets or exceeds the assigned security level for the particular region. The integrated circuit also performs sandboxing by assigning which of the plurality of processing devices are permitted access to each of the plurality of regions. The integrated circuit may implement only the security level function or only the sandboxing function, or the integrated circuit may implement them both. In some instances, a scrambling/descrambling function is included to scramble/descramble data. In one application, the integrated circuit is included within a mobile phone.

### CROSS REFERENCE TO RELATED APPLICATION

This application claims the benefit of priority to U.S. Provisional Application having an application No. 61/300,798, filed Feb. 2, 2010, and titled “Apparatus and method for partitioning, sandboxing and protecting external memories” which is incorporated herein by reference in its entirety.

### BACKGROUND OF THE INVENTION

1. Technical Field of the Invention

The present invention relates generally to processing devices and, more particularly, to controlling accesses to a memory by a plurality of processing devices.

2. Description of Related Art

Accessing of a memory by a processing device, such as a processor, is generally known.

In a basic scheme, such as in a personal computer (PC), a single processor, such as a CPU (central processing unit) accesses an on board memory, such as RAM (random-access-memory). In more complicated systems, the memory may be accessed by multiple processors or a single processor with multiple processing cores. In some instances, the memory may be shared by a number of processors. The access control may be controlled by the processor or by a separate device, such as a memory management unit (MMU).

However, in many of these memory accessing schemes involving multiple processors, the processors that access the memory are of the same type (homogeneous). Similarly, where the memory is partitioned into different partitions, such as segments or pages, the partitioned space is either exclusive to one processor or shared by all the processors. These types of schemes may have their advantages in certain applications where homogeneous processors are employed, but as systems are more integrated, these types of system have limitations. For example, in a mobile environment, where more and more functions are constructed on a single integrated chip, the systems that are integrated on the chip may require a more flexible and secure memory access management, especially in the instance where heterogeneous processing devices are accessing the memory.

Therefore, a need exists to provide a more robust memory accessing scheme for a system that employs multiple processing devices.

### SUMMARY OF THE INVENTION

The present invention is directed to apparatus and methods of operation that are further described in the following Brief Description of the Drawings, the Detailed Description of the Invention, and the Claims. Other features and advantages of the present invention will become apparent from the following detailed description of the embodiments of the invention made with reference to the accompanying drawings.

### BRIEF DESCRIPTION OF THE DRAWINGS

FIG. 1 is a block diagram of one embodiment of a memory accessing scheme that utilizes a memory protection unit (MPU) of the present invention.

FIG. 2 is a block diagram illustrating functional modules of the MPU of FIG. 1 in allowing a master processing device to access a partitioned memory having a plurality of partitioned regions.

FIG. 3 is a block diagram of a partitioning module for the MPU of FIG. 2 to provide partitioning of the memory.

FIG. 4 is a block diagram of a security module for the MPU of FIG. 2 to provide security access to the partitioned regions of the memory.

FIG. 5 is a block diagram of a sandboxing module for the MPU of FIG. 2 to provide device access control to the partitioned regions of the memory.

FIG. 6 is a block diagram of a scrambling/descrambling module for the MPU of FIG. 2 to provide scrambling/descrambling operation respectively on the data written to or read from the partitioned regions of the memory.

FIG. 7 is a flow diagram illustrating an operation of the MPU of FIG. 2 in initializing the memory.

FIG. 8 is a flow diagram illustrating a typical operation of the MPU of FIG. 2 after partitioning.

FIG. 9 is a block diagram of a system that incorporates the MPU of FIG. 2 in a device that includes a radio portion for wireless communication.

FIG. 10 is an example that illustrates the use of the device of FIG. 9 in a mobile phone.

### DETAILED DESCRIPTION OF THE INVENTION

The embodiments of the present invention may be practiced in a variety of settings that utilize multiple processing devices which access the same memory. The described embodiments below pertain to a particular memory protection unit (MPU), but other embodiments may have other name designations. Furthermore, the application of the described embodiment pertains to a mobile phone, but the invention need not be limited to mobile or other wireless applications. The invention may be utilized in wired settings, such as wired networks or other environments having physical conductive connections. The invention is applicable in a setting where multiple devices access the same memory and where access control is desired for the memory.

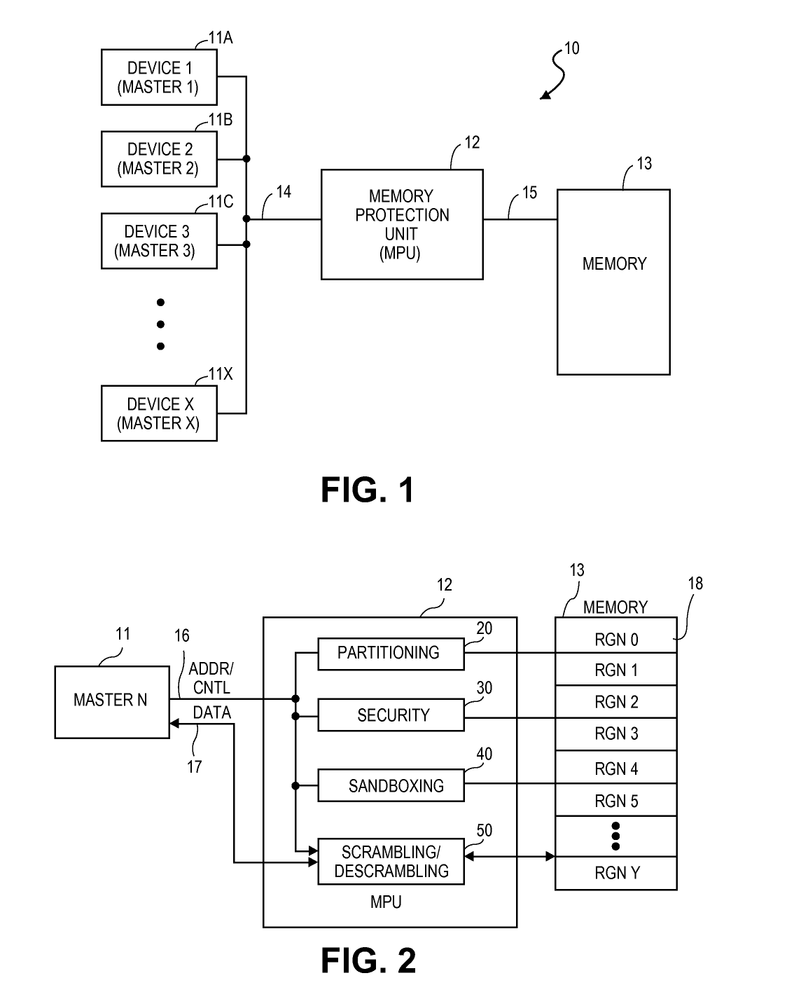

FIG. 1 illustrates a block diagram of one embodiment of a memory accessing scheme that utilizes a memory protection unit (MPU) 12 of the present invention. MPU 12 is shown as part of system 10 and coupled to a plurality of processing devices 11A-11X, where “X” is an arbitrary integer. Processing devices 11A-11X are generally referred to herein as device(s) 11. The actual number of such devices 11 present in system 10 varies, provided at least two such devices 11 are present. That is, MPU 12 is coupled to a plurality of processing devices 11, by a connection 14, to communicate with MPU 12. MPU 12 is also coupled to a memory 13 by a connection 15. Typically, a bus is used for the connection 14 or 15, however, connection 14 and 15 need not be limited to a bus. Furthermore, although one connection is shown for each connection 14 or 15, in some embodiments, connection 14 and/or 15 may each comprise multiple connections (e.g. busses). In some embodiments, connections 14 and 15 may be the same connection, such as a system bus.

In system 10, not all of the processing devices 11 are of the same type. Thus, system 10 includes processing devices 11 that provide a multiplicity of functions that utilize different types of processors and may include processing devices of different processing architectures. For example, a separate processing device 11 may be present to operate as a central processing unit (CPU), as a video accelerator, as an audio accelerator, as a DMA (direct memory access) controller, as an application processor for a host, as a baseband processor, as a DSP (digital-signal-processor), as an encryption and/or decryption engine, as a bus bridge, as a peripheral interface, as a master for accessing external devices (such as SIDO, USB, Flash), etc. These functions are presented as examples only and do not limit the functionality of processing devices 11.

Although one or more processing devices may provide the same or similar functions in some embodiments, the overall system 10 includes processing devices that provide dissimilar operations and each of processing devices 11 may operate as a master. It is generally known that a master device communicates with a slave device. A master may also communicate with a memory to effect a data transfer between the memory and the master, or effect a data transfer between the memory and the slave via the master. In system 10, each processing device 10 may operate as a master to effect data transfer between it and memory 13 or between the particular master's slave and memory 13 via the master.

MPU 12 is utilized to control the access to memory 13 by the plurality of processing devices 11, which may operate as master devices within system 10. As noted above, due to the various different functions, not all of the processing devices 11 may conform to a particular processing type or processing architecture and, therefore, present heterogeneous (non-homogeneous) processing device operations. MPU 12 controls the accesses to memory 13 by these heterogeneous processing devices. The operation of MPU 12 is described in more detail below in reference to FIGS. 2-10.

Memory 13 may be one memory device or a plurality of memory devices that are typically mapped as a single logical memory space. Any of a variety of volatile or non-volatile memory devices may be used for memory 13, including random-access-memory (RAM), static random-access-memory (SRAM), dynamic random-access-memory (DRAM), read-only-memory (ROM), flash memory, erasable programmable memory, cache memory, optical memory, magnetic memory, etc. In one embodiment, memory 13 is a synchronous dynamic RAM (SDRAM). These memory devices are noted as examples only and the types of memory that may be used for memory 13 are not limited by the above list. What is to be noted is that in system 10, a processing device 11, designated as a master device, is permitted access to memory 13 under control of MPU 12. Thus, in system 10, each processing device 11 may operate as a master and there may be multiple masters operating within system 10. Whenever a processing device accesses memory 13, its accesses are controlled by MPU 12.

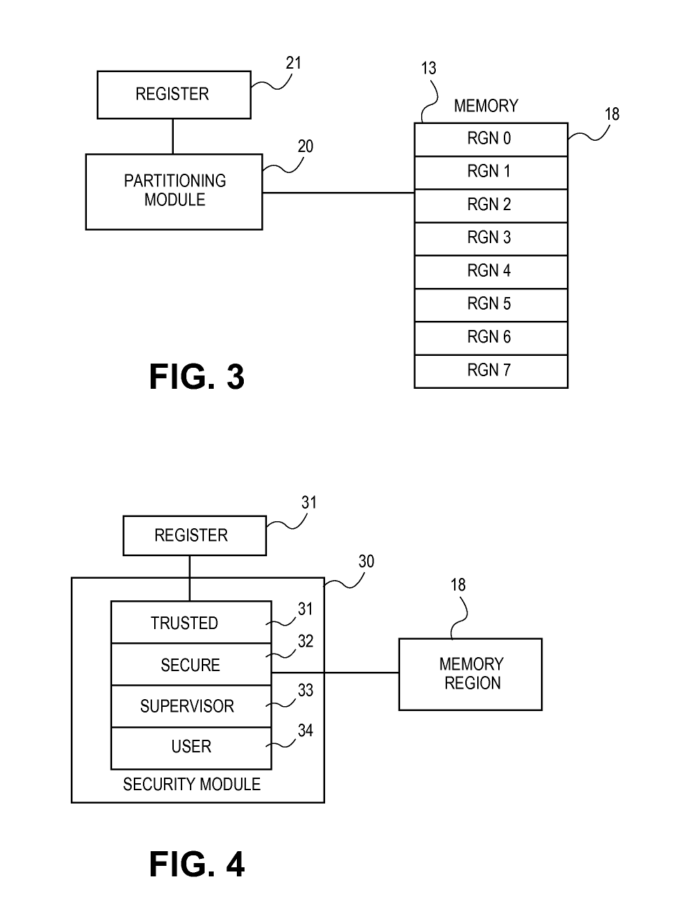

FIG. 2 shows a more detailed illustration of MPU 12, in which one of the processing devices operates as a master (noted as Master N, where N is an arbitrary number) to access memory 13. As an example, Master N may be an ARM processor in one embodiment. An ARM processor uses a RISC (Reduced Instruction Set Computing) architecture. Memory 13 is also shown partitioned into a plurality of partitioned areas noted as regions (RGN) 18. The actual number of partitioned regions varies from embodiment to embodiment. Memory 13 of FIG. 2 is shown having RGN0 through RGN Y, where Y is an integer. In one embodiment, memory 13 has 8 regions (RGN0-RGN7) as shown in FIG. 3.

The particular MPU 12 shown in FIG. 2 includes a partitioning module 20, a security module 30, sandboxing module 40 and scrambling/descrambling module 50. However, in other embodiments, MPU 12 may include only partitioning module 20 or partitioning module 20 combined with one or more of security module 30, sandboxing module 40 and/or scrambling/descrambling module 50. That is, MPU 12 may have just the partitioning module present or MPU 12 may have the partitioning module, as well as one or more of the other modules 30, 40, 50 present. The term scrambling/descrambling is used herein to denote the operation of scrambling/descrambling data to alter the format of the data so that the data content is unintelligible when scrambled. Although the term data scrambling/descrambling is used herein, other operations such as encryption/decryption, encoding/decoding, crypting/decrypting, etc. are also applicable as analogous operations that may be performed by scrambling/descrambling module 50.

Address and control lines are shown coupled to the various modules 20, 30, 40 and 50 via bus 16 and the data is coupled to scrambling/descrambling module 50 via bus 17. Again, if a particular module 30, 40, 50 is not present (or not enabled), the particular function described below for that module is not utilized within MPU 12. When scrambling/descrambling module 50 is not present or not enabled, the data is coupled through MPU 12, but without having any scrambling/descrambling performed. It is to be noted that bus 16 and bus 17 are shown as connections between master 11 and MPU 12 and may be a single connection, such as connection 14 of FIG. 1 or multiple connections. In one embodiment, AMBA (Advanced Microcontroller Bus Architecture) is utilized as an on-chip bus architecture, in which APB (Advanced Peripheral Bus) and/or AXI (Advanced eXtensible Interface) are used within the chip. However, it is to be noted that a variety of buses, interfaces and bus architectures may be implemented.

FIG. 3 shows the functionality of partitioning module 20. Partitioning module 20 performs the function of partitioning memory 13 into a predetermined number of regions 18. In the shown embodiment of FIG. 3, memory 13 is partitioned into eight regions, noted as RGN0-RGN7. Although the regions may be partitioned to have different sizes, in one embodiment each region is partitioned to have a preselected page size and in another embodiment, there is a minimum page size but no limit to set a maximum page size. As an example, in one embodiment, each region 18 may be mapped to a page boundary, such as a 4 KB page boundary. The partitioning of the regions may be programmed and, in one embodiment, a partitioning configuration register 21 is utilized to configure each region 18. Other embodiments may use other schemes to programmably configure the regions. As noted above, in one embodiment for MPU 12, only the partitioning function is present or enabled within MPU 12 to provide only the partitioning function.

FIG. 4 shows the functionality of setting a security level for each memory region 18, when the security function is utilized by MPU 12. Security module 30 assigns a level of security that determines an access type authorized for each region 18 of memory 13. That is, each region 18 is assigned a particular security level for transactions accessing that particular region 18. The actual number of security levels that are assignable varies from embodiment to embodiment. In the particular example, four possible security levels are available to determine the access type. The four levels of security, from the highest security level to the lowest, are designated Trusted (block 31), Secure (block 32), Supervisor (block 33) and User (block 34). It is to be noted that other security hierarchy structures may have other labels for the levels, as well as different number of levels. After memory 13 is partitioned into regions 18, security module assigns a security level to each memory region 18. The security levels for each region may be established through a boot-up or reset routine or, alternatively, the security levels may be programmed, such as through a programmable configuration register 31. The manner in which the security level is set for each region 18 is not critical to the practice of the invention, as long as a security level is established.

The security level hierarchy is established so that a particular region is accessible by a transaction that denotes the security for that level or higher. For example, since Trusted is the highest security level in the security hierarchy, any transaction having the Trusted label is authorized to access any region by security module 30. As another example, any transaction having the Secure label is authorized to access a region having Secure, Supervisor or User security level by security module 30, but not any region having the Trusted level. During operation, it is to be noted that the security check for a transaction is checked by security module 30 for security authorization and access is permitted when the security level of the transaction is equal to or higher than the security designation of the region. The access is permitted, provided other necessary conditions for access are met.

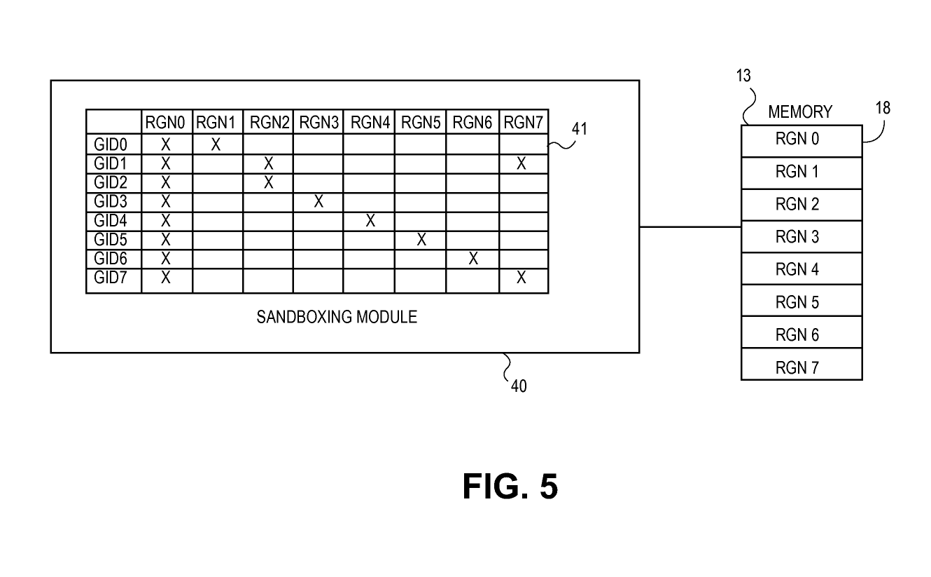

FIG. 5 shows the functionality of setting sandboxing parameters for each memory region 18, when the sandboxing function is utilized by MPU 12. Generally, sandboxing is a computer security mechanism that separates running software so that certain software routines are segregated from other routines or resources. Sandboxing module 40 provides a sandboxing function in regards to memory 13 by segregating which region or regions are accessed by which processing devices 11. The sandboxing function may be implemented by MPU 12 with or without the security function provided by security module 30. In one embodiment, sandboxing module 40 assigns which processing device or devices may access each region 18. In another implemented embodiment, each processing device 11 is assigned to a particular group. That is, each master device is assigned to a master group, noted as having a Group Identification (GID#), as shown in FIG. 5.

In the shown embodiment of FIG. 5, sandboxing module 40 is programmed to assign each master to a master group noted by GID#. Eight master groups, GID0-GID7, are utilized in the embodiment shown, but it is understood that other embodiments may have master groups other than eight. A cross-reference table 41 is programmed within sandboxing module 40 to identify which region or regions 18 of memory 13 may be accessed by each master group. When in operation, a transaction is checked to determine which processing device is accessing a particular region. The processing device is checked to determine its group (if grouping is used) and table 41 is checked to determine if the access to that region is permitted for that group. Access is only permitted if the sandboxing check allows the processing device (or the group to which it belongs) is authorized to access that particular region 18. The sandboxing is a different security function separate from the security type function described in reference to security module 30. The sandboxing isolates a processing device (or the group to which the processing device is assigned, if group scheme is utilized) to a particular region or regions of memory and prohibits access to non-authorized region(s). Note that the security function provided by security module 30 deals with a security level assigned to a memory region, where as sandboxing deals with assigning which device(s) (or group of devices) has/have access to a region.

The sandboxing check may be performed in sequence or in parallel with the security type check provided by security module 30, when security module is also utilized for a given transaction along with sandboxing module 40. It is possible that when both security and sandboxing functions are utilized, a particular access by a device may pass one condition (either sandboxing or security level access) but fail the other, so that the particular access is not permitted to the desired region.

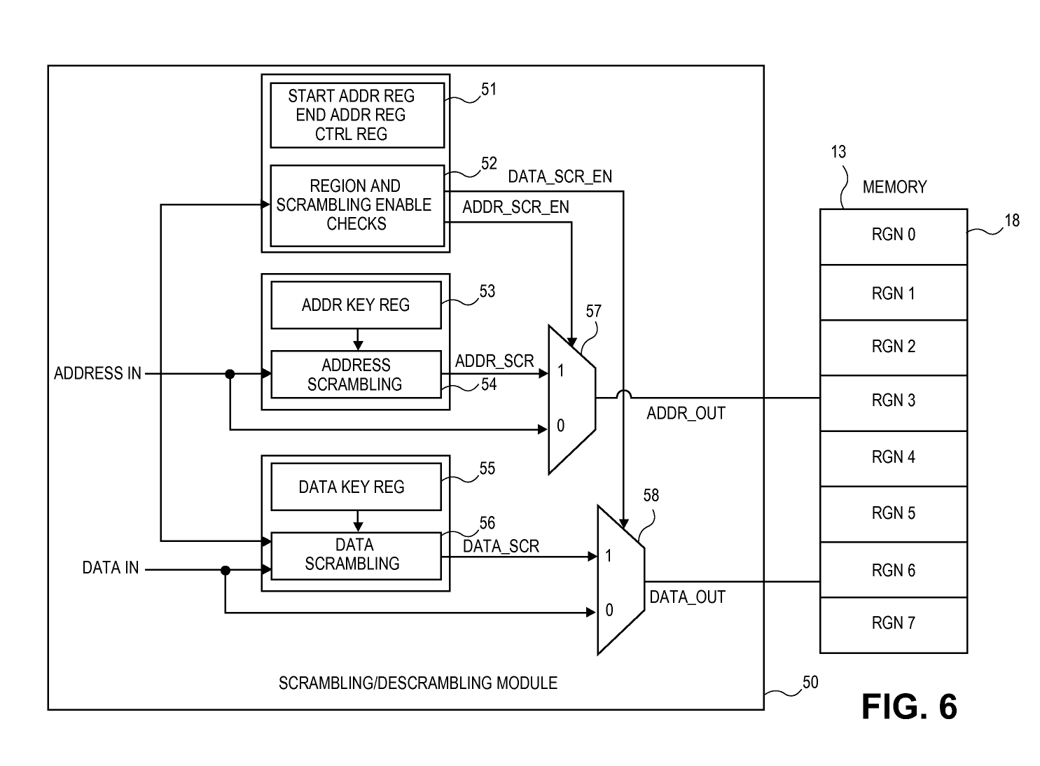

FIG. 6 shows the functionality of scrambling/descrambling module 50, when the scrambling function and/or the descrambling function is/are utilized by MPU 12. As noted above, the term data scrambling/descrambling is used herein, but other operations such as encryption/decryption, encoding/decoding, crypting/decrypting, etc. are also applicable for use for module 50. In one embodiment, shown in FIG. 6, scrambling/descrambling module 50 is utilized to scramble only portions of the data written to memory 13 and to descramble the data when scrambled data is read from memory 13. In other embodiments, all data may be scrambled/descrambled or, alternatively, none of the data are scrambled/descrambled.

The particular embodiment shown in FIG. 6 scrambles only selected data identified for scrambling when the scrambling/descrambling feature is enabled. The default condition is with the scrambling/descrambling feature turned off. In the shown embodiment, the address and data inputs to scrambling/descrambling module 50 are scrambled separately using different keys. The address input is scrambled by address scrambling module 54 based on the address key stored in address key register 53. Multiplexer (MUX) 57 is used to select between scrambled address and unscrambled address (normal address) output to memory 13. Likewise, the data input is scrambled by data scrambling module 56 based on the data key stored in data key register 55. In another technique, scrambling may use an address along with data key for scrambling. This provides better scrambling algorithm, since the same data written to the memory will have different values based on their address. MUX 58 is used to select between scrambled data and unscrambled data (normal data) output to memory 13. In some embodiments, only data or address is scrambled, while in other embodiments both may be scrambled together using a single key or different key as noted above.

In order to determine which address range is active to scrambling, a set of registers 51 are used. A start address register holds the starting address and an end address register holds the end address for determining the address range. A control register may also be present to program configuration settings for configuring the address range or region(s) that are to receive the scrambled data. It is to be noted that the range of addresses may be set for a particular region, a portion of a region or cover more than one region. In some embodiments, different non-contiguous areas or regions of memory 13 may be designated for scrambling by use of multiple start and end address registers.

In operation, when a transaction is received, scrambling checks are performed by scrambling enable module 52 to determine if the address fits within the scrambling range (or region, when scrambling is performed by region) and sends control signals to MUXs 57, 58. Scrambling is selected if scrambling/descrambling is enabled and the address of the transaction falls within the range of addresses (or region) for scrambling/descrambling. Otherwise, non-scrambled operation is selected. It is appreciated that various other embodiments may be implemented for scrambling/descrambling module 50 to perform equivalent operations. For descrambling, the operations are equivalent, except that the data that is read from memory is descrambled for output back to a master.

It is to be noted that the scrambling/descrambling function may be utilized along with either or both security module 30 and/or sandboxing module 40. In other embodiments, the scrambling/descrambling may be utilized with the partitioning module 20, without the use of security module 30 and sandboxing module 40.

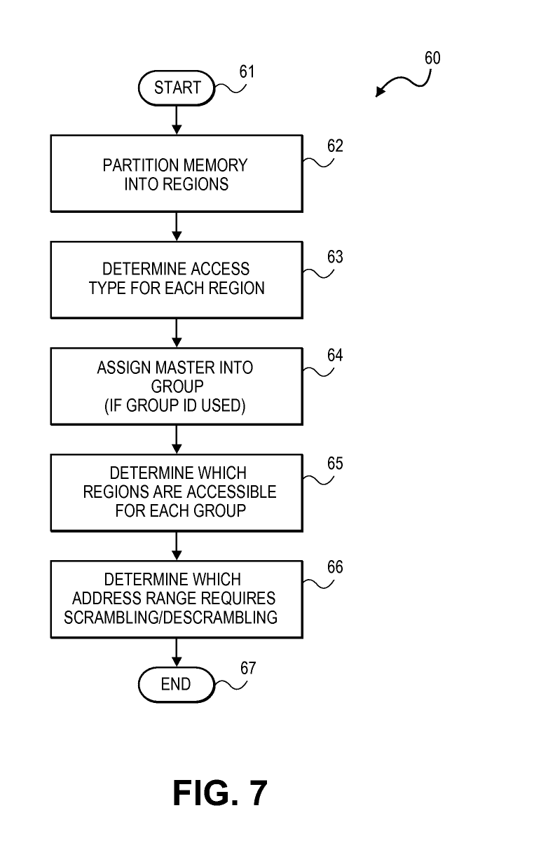

FIG. 7 is a flow diagram 60 that shows a process performed by MPU 12 to configure MPU settings. At boot-up, reset or some other initialization condition after start (block 61), MPU 12 partitions memory 13 into a plurality of regions 18 (block 62). In one embodiment, each region is set on a page boundary, such as a 4 KB boundary. Then, each region is assigned a security level based on the security access type (block 63), if this security function feature is used. In the embodiment described above, four security levels are used. Next, or in parallel with assigning the security level, sandboxing is performed to assign each master to a group (block 64) and each group is cross-referenced with the region or regions permitted access (block 65), is the sandboxing feature is used. In some embodiments, masters may be assigned to a region directly without the use of groupings. Then, if scrambling is utilized, an address range is set for data and/or the address that fits within the address range for scrambling (block 66), at which point the set up process is complete (block 67).

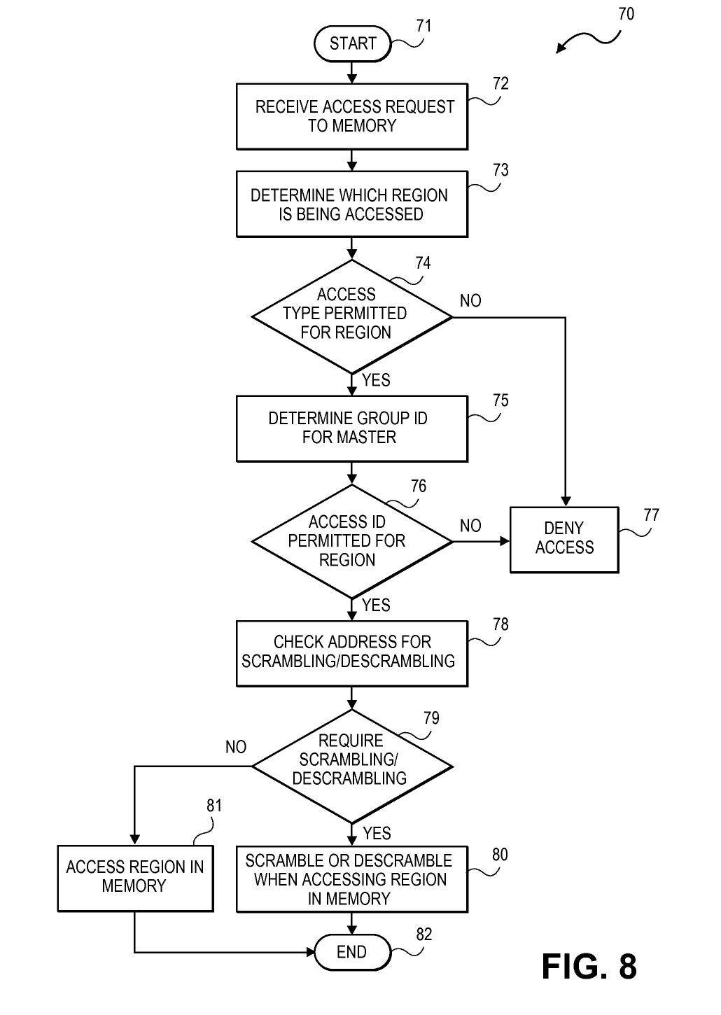

FIG. 8 is a flow diagram 70 that shows MPU 12 in operation after the memory partitioning and access controls are established. The method begins (block 71) when a memory access transaction, such as a read or a write transaction is initiated by a master. All memory accesses are controlled by MPU 12 so that MPU 12 receives the access request (block 72) and determines which region 18 of memory 12 contains the address of the access (block 73). Security module 30 then performs a security type check by determining if the security level noted in the transaction is at the same level or higher than the level assigned to the region being accessed (block 74), if this security feature is used. If the security level of the transaction is at or higher than the level assigned to the region, the access is permitted, otherwise the access is denied (block 77). Next, when used, sandboxing is performed by identifying a group ID for the master device attempting access (block 75) and cross-referenced to determine if access to the attempted region is permitted for that group (block 76). If permitted for the group, then access is permitted, otherwise the access is denied (block 77). Note that the order of performing the security type check and the sandboxing check may be performed in any order or performed at the same time. Furthermore, if access check fails in either of the checks, the transaction is denied access to the memory. Additionally, as noted above, some embodiments may not use the grouping scheme and may cross reference each master to a region.

Then, if access is permitted for the enabled checks, the address is checked (block 78) to determine if scrambling function is to be performed for the address and/or the data (assuming that scrambling is enabled) that is being written to memory 13 or descrambling is to be performed for data read from memory 13 (block 79). Scrambling/descrambling is performed if the address check requires scrambling/descrambling (block 80) for the access to the memory, otherwise the transaction does not require scrambling/descrambling (block 81) to access the memory. When the access is completed, the MPU procedure ends (block 82). It is to be noted that the flow diagrams of FIGS. 7 and 8 are just two examples and other processes may be performed within the spirit and scope of the invention.

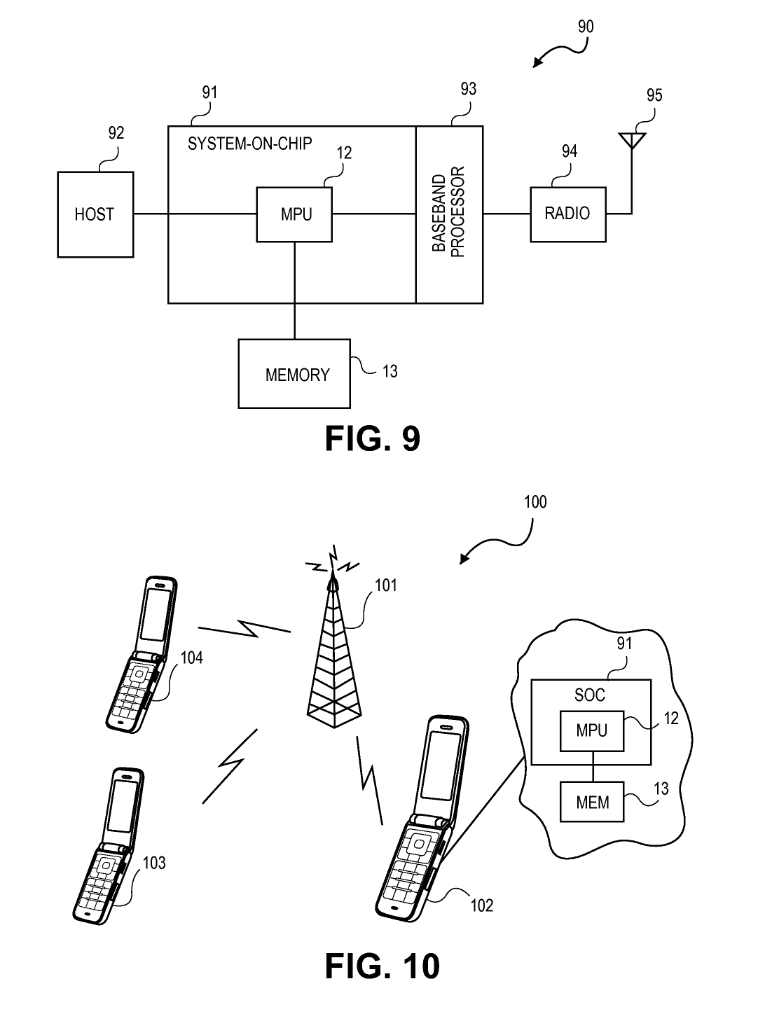

MPU 12 may be implemented in a variety of components, circuits, devices, processors, state machines, programmable arrays, etc. In one application shown in FIG. 9, MPU 12 is implemented within a single integrated circuit (IC) chip 91 that incorporates a complete system on the IC chip (system-on-chip or SOC). The plurality of processing devices 11 that operate as masters may also be incorporated within the SOC IC 91 as well, although in other embodiments, one or more of the processing devices may be external to IC 91. Memory 13 is shown as an external memory in FIG. 9 and resides external to IC 91. However, other embodiments may have all of memory 13 or portion of memory 13 within IC 91. In one embodiment, MPU 12 is operable to control an external memory and an internal memory, such as an internal scratch memory or internal cache memory. Generally, MPU 12 described above may be employed to control memory partitioning and access to memory 13.

The particular wireless device 90 shown in FIG. 9 is a wireless device that is used to transmit and receive wireless communication. For wireless communication, a baseband processor (or baseband processing module) is present to provide baseband processing and a radio component is typically present to provide the baseband to radio frequency (RF) conversion. The radio also includes a transmitter and receiver (transceiver) to transmit and receive RF signals. Accordingly, wireless device 90 includes a baseband processor 93 and radio 94. Radio 94 is coupled to an antenna 95, or a plurality of antennas for multiple antenna transmissions and/or receptions. A variety of baseband processing devices and radio devices, including known devices, may be respectively implemented for baseband processor 93 and radio 94. In some embodiments, baseband processor 93 may be part of IC 91. In other embodiments, both baseband processor 93 and radio 94 may be part of IC 91.

Furthermore, a host component or device 92 may be present and coupled to operate with IC 91. A variety of host components, such as displays, keypads, touch pads, speakers, head phones, microphones and other user interfaces may encompass host 92. In some embodiments, part of or all of host 92 may be included within IC 91.

It is to be noted that in some embodiments, processing devices of baseband processor 93, radio 94 and/or host 92 may utilize memory 13, wherein MPU 12 may control access to memory 13 as described above for those processing devices as well, along with devices of IC 91.

FIG. 10 shows one example application for device 90. As shown in FIG. 10, device 90 is implemented in a mobile phone 102, such as a cell phone. The particular mobile phone operates within a cellular network 100 that includes a base station 101 and other mobile phones, of which two other mobile phones 103, 104 are shown. The various functional blocks of MPU 12 as described above allows multiple heterogeneous processing devices to access memory 13, which typically is limited in size due to the physical size and battery power consumption restrictions placed on mobile phones. However, the accesses to the memory are controlled and security maintained through the security, sandboxing and scrambling/descrambling schemes described above for the partitioned regions of the memory.

Accordingly, a technique for partitioning, sandboxing and protecting external memory or memories is described. It is to be noted that a variety of embodiments may be implemented to practice the invention. Some of the embodiments are noted in the above description. Other embodiments may be practiced as well. For example, in a different embodiment, one or more memory regions (such as the regions shown in FIGS. 2 and 3) may actually overlap with another region or regions. In that instance, various rules may be established as to how to control the access to those overlapped areas or regions. As an example, security settings may be used as a primary condition for accessing an overlapped area or region. Other conditions may be employed in other embodiments. As another example, a region may not be contiguous in memory. As with many memory mapping techniques, a particular region RGN may be mapped having non-contiguous memory space.

Furthermore, as an example of additional embodiments for practicing the invention, various instructions may be employed to access the memory, beyond the “read” and “write” instructions noted above. For example, “load” and “store” instructions, as well as other instructions, may be used to access the memory, in which the partitioning, security, sandboxing and/or scrambling/descrambling techniques may be applied with those instructions. Additionally, “read-from-memory” type instruction and “write-to-memory” type instruction may be processed differently in accessing the partitioned memory. That is, a read-type instruction may have different partitioning, security, sandboxing and/or scrambling/descrambling requirement(s) applied from a corresponding write-type instruction in accessing a partitioned memory space. Many other examples abound that are within the spirit and scope of the present invention.

As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. An apparatus comprising:
a memory partitioning module to partition a memory into a plurality of regions, in which the memory is accessed by a plurality of heterogeneous processing devices that operate to access the memory;
a security module to assign a security level for each region of the memory and permit a memory access by a transaction to a particular region of the memory, only when a level of security assigned to the transaction meets or exceeds the assigned security level for the particular region; and
a sandboxing module to assign which of the plurality of processing devices are permitted access to each of the plurality of regions, based on a sandboxing scheme independent of the assigned security level.

2. The apparatus of claim 1, wherein the memory partitioning module, security module and the sandboxing module are constructed on a single integrated circuit chip as a system-on-chip (SOC).

3. The apparatus of claim 2, wherein the plurality of heterogeneous processing devices are also constructed on the integrated circuit as part of the SOC.

4. The apparatus of claim 2, further comprising a scrambling and descrambling module to scramble data prior to writing the data to the memory when the transaction is a write transaction and descrambling data when reading scrambled data from the memory when the transaction is a read transaction.

5. The apparatus of claim 2, wherein the sandboxing module assigns the plurality of processing devices into processing groups and assigns which of the processing groups are permitted access to each of the plurality of regions.

6. The apparatus of claim 2, wherein the memory is external to the integrated circuit forming the SOC.

7. The apparatus of claim 2, wherein the SOC is implemented as part of a mobile phone.

8. An apparatus comprising:
a memory partitioning module to partition a memory into a plurality of regions, in which the memory is accessed by a plurality of heterogeneous processing devices that operate to access the memory; and
a security module to assign a security level for each region of the memory and permit a memory access by a transaction to a particular region of the memory, only when a level of security assigned to the transaction meets or exceeds the assigned security level for the particular region, wherein the memory partitioning module and the security module are constructed on a single integrated circuit chip as a system-on-chip (SOC).

9. The apparatus of claim 8, further comprising a scrambling and descrambling module to scramble data prior to writing the data to the memory when the transaction is a write transaction and descrambling data when reading scrambled data from the memory when the transaction is a read transaction, the scrambling and descrambling module operable to function with the security module in accessing the memory.

10. The apparatus of claim 8, wherein the plurality of heterogeneous processing devices are also constructed on the integrated circuit as part of the SOC and implemented as part of a mobile phone.

11. The apparatus of claim 8, wherein one or more of the regions overlap in the memory.

12. An apparatus comprising:
a memory partitioning module to partition a memory into a plurality of regions, in which the memory is accessed by a plurality of heterogeneous processing devices that operate to access the memory; and
a sandboxing module to assign which of the plurality of processing devices are permitted access to each of the plurality of regions, based on a sandboxing scheme for the plurality of heterogeneous processing devices.

13. The apparatus of claim 12, wherein the sandboxing module assigns the plurality of processing devices into processing groups and assigns which of the processing groups are permitted access to each of the plurality of regions.

14. The apparatus of claim 13, further comprising a scrambling and descrambling module to scramble data prior to writing the data to the memory when the transaction is a write transaction and descrambling data when reading scrambled data from the memory when the transaction is a read transaction, the scrambling and descrambling module operable to function with the sandboxing module in accessing the memory.

15. The apparatus of claim 13, wherein the plurality of heterogeneous processing devices are also constructed on the integrated circuit as part of the SOC.

16. The apparatus of claim 13, wherein the SOC is implemented as part of a mobile phone.

17. A method comprising:
partitioning a memory into a plurality of regions, in which the memory is accessed by a plurality of heterogeneous processing devices that operate to access the memory;
assigning a security level for each region of the memory, in order to permit a memory access by a transaction to a particular region of the memory, only when a level of security assigned to the transaction meets or exceeds the assigned security level for the particular region; and
assigning which of the plurality of processing devices are permitted access to each of the plurality of regions, based on a sandboxing scheme independent of the assigned security level.

18. The method of claim 17, wherein the assigning of which of the plurality of processing devices are permitted access to each of the plurality of regions further includes assigning the plurality of processing devices into processing groups and assigning which of the processing groups are permitted access to each of the plurality of regions.

19. The method of claim 18, further comprising scrambling data prior to writing the data to the memory when the transaction is a write transaction and descrambling data when reading scrambled data from the memory when the transaction is a read transaction.

20. The method of claim 18, wherein the partitioning the memory is performed on a memory that is located external to an integrated circuit that contains circuitry that performs the partitioning, assigning the security level and assigning the processing groups.
